(19) United States
(12) Patent Application Publication
(10) Pub. No.: US 2008/0291377 A1
(43) Pub. Date: Nov. 27, 2008

(54) Liquid Crystal Display Device and Manufacturing Method Thereof

(76) Inventors: Shinji SEKIGUCHI, Kawasaki (JP); Yasushi Sano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/104,736

(22) Filed: Apr. 17, 2008

(30) Foreign Application Priority Data
Apr. 26, 2007 (JP) 2007-117070

(51) Int. Cl. G02F 1/1335; G02F 1/13363; G02F 1/13

(52) U.S. Cl. 349/114; 349/117; 349/187

(57) ABSTRACT

For attaining a transflective liquid crystal display device of high fineness having a built-in retardation plate in a reflective display area, a retardation plate (layer) disposed to the inner surface of the liquid crystal display device is formed by using a liquid-crystalline acrylate monomer with addition of a photopolymerization initiator having a phosphine oxide structure.

The present application claims priority from Japanese application JP 2007-117070 filed on Apr. 26, 2007, the content of which is hereby incorporated by reference into this application.

### BACKGROUND OF THE INVENTION

1. Field of the Invention

The present invention concerns a liquid crystal display device and it particularly relates to a liquid crystal display device capable of reflective display in a wide range of circumstances including from a light place to a dark place and capable of transmissive display with a wide view angle and a high image quality, and a manufacturing method thereof.

2. Description of the Related Art

At present, transmission type liquid crystal display devices with a wide view angle of an IPS (In Plane Switching) system or VA (Vertical Alignment) system have been popularized as monitors for various equipments and also used for televisions while improving response characteristics. On the other hand, liquid crystal display devices have also been popularized in mobile information equipments including mobile phones and digital cameras. The mobile information equipments are mainly used personally and those having an angle-variable display area have been increased and a wide view angle is demanded since they are often observed from an oblique direction.

Since display devices for use in the mobile information equipments have been used in various circumstances including from outdoors in fine weather to dark rooms, it is desired the devices are transflective. Transflective liquid crystal display device has a reflective display area and a transmissive display area in one pixel.

The reflective display area reflects light incident from the periphery by using a reflection plate to conduct display and, since a contrast ratio thereof is constant irrespective of the surrounding brightness, favorable display can be obtained in a relatively bright circumstance including from outdoors in fine weather to the inside of rooms. On the other hand, since the transmissive display area provides a constant luminance by using a backlight irrespective of the circumstance, a display at a high contrast ratio is obtained in a relatively dark circumstance from the indoor to the dark room. The transreflective liquid crystal display device having both of the characteristics can provide display at a high contrast ratio in a wide range of circumstances including from outdoors in fine weather to dark room.

Heretofore, it has been expected that reflective display and transmissive display with a wide view angle can be obtained together by making the IPS system which is known to provide a transmission device with a wide view angle into a transflection type. For example, Japanese Unexamined Patent Application Publication (JP-A) No. Hei 11 (1999)-242226 (corresponding to U.S. Pat. No. 6,281,952) describes a transflection type IPS system.

In the transflection type IPS system liquid crystal display device, retardation plates are disposed to the entire outer surface on upper and lower sides of a liquid crystal panel, in which a liquid crystal layer is sealed between two transparent substrates. However, since the retardation plate has view angle dependency, even when the phase difference between the liquid crystal layer and a plurality of retardation plates, and the arrangement of axes are optimized in the normal direction of the liquid crystal layer, they deviate from the optimal conditions for dark display suddenly as apart from the normal direction.

While the view angle dependency of the retardation plate can be decreased by controlling the refractive index in the direction of the thickness of the retardation plate but it cannot be eliminated completely. As a result, in the transflection type IPS system, the dark display transmittance increases greatly in the direction of the view angle and the view angle characteristic of the transmissive display thereof is lower compared with that of the transmission type IPS system.

Further, the structure for the arrangement and the display characteristic in a case where a retardation plate (retardation layer) is housed to the inside of a panel instead of an externally added retardation plate are disclosed by C. Doornkamp et al., in Philips Research, “Next generation mobile LCDs with in-cell retarders.” International Display Workshops 2003, p 685 (2003).

In JP-A-2003-279957, the retardation layer is disposed so as to be close to the liquid crystal layer in the VA system and patterned and disposed only to the reflective display area. However, application to the IPS system that provides transmissive display with a wide view angle is not taken into consideration. Further, JP-A-2005-338256 (corresponding to U.S. Pat. No. 7,088,409) discloses consideration for making the transflection type IPS system having a built-in retardation layer with a wide view angle equivalent with that of the transmission type IPS system.

In the transmission type IPS system, the liquid crystal layer is aligned homogeneously, and polarizer plates disposed to the outer surfaces of a first substrate and a second substrate (upper and lower polarizer plates) are disposed such that the transmission axes are perpendicular to each other and one of the transmission axes is made in parallel with the aligning direction of the liquid crystal layer. Since light incident to the liquid crystal layer is a linearly polarized light and the oscillation direction thereof is in parallel with the aligning direction of the liquid crystal layer, phase difference is not provided by the liquid crystal layer. This can obtain dark display at a low transmittance and since a retardation layer (retardation plate) is not interposed between the liquid crystal layer and the polarizer plate, no surplus phase difference is caused in the direction of the view angle and dark display with a wide view angle can be attained. As described above, the transmission type IPS system does not essentially require the retardation layer (retardation plate).

A transflection type liquid crystal display device has, in one pixel, a reflective display area and a transmissive display area essentially different from each other in the optical condition for dark display. That is, in the reflective display area, light is incident from a polarizer plate on the side of a substrate (first substrate) at the upper surface of a liquid crystal panel constituting a liquid crystal display device, reflected at a reflection plate inside the liquid crystal panel, then passed through the polarizer plate at the upper surface again and directed to a user. On the other hand, in the transmissive display area, light is incident from a polarizer plate on the side of a substrate (second substrate) at the lower surface of the liquid crystal panel, then passed through the polarizer plate at the upper surface of the liquid crystal panel and directed to the user.

Due to the difference of the optical channel described above, the phase difference of light as the dark display is different by ¼ wavelength between the reflective display area and the transmissive display area. Accordingly, the transmissive display area provides dark display when the reflective display area provides bright display, and vise versa. The reflective display area and the transmissive display area have application voltage dependency different from each other. For making them into identical application voltage dependency, the phase difference between the reflective display area and the transmissive display area has to be shifted by ¼ wavelength by some or other means.

In the existent transflection type IPS system, a retardation plate is disposed over the entire surface (outer surface) of upper and lower sides of the liquid crystal panel. Among them, in the retardation plate on the upper side (first substrate side) of the liquid crystal panel, light incident from the outside to the reflective display area, light reflected at the reflection plate of the reflective display area, and light passing the transmissive display area are passed. Thus, the upper retardation plate acts both on the reflective display area and the transmissive display area. On the other hand, in the retardation plate on the lower side (second substrate side) of the liquid crystal panel, since only the optical source light incident to the transmissive display area is passed, it acts only on the transmissive display area. By utilizing the difference of the operation between the upper side retardation plate and the lower side retardation plate to the reflective display area and the transmissive display area, the phase difference between them is shifted by ¼ wavelength. However, since the phase difference plate is interposed between the liquid crystal layer and the polarizer plate, surplus phase difference is caused in the direction of the view angle to lower the view angle characteristic for the dark display.

Further, in the transflection type IPS system having a built-in function of a retardation plate in a liquid crystal panel as a retardation layer as disclosed in JP-A-2005-338256 (corresponding to U.S. Pat. No. 7,088,409), the retardation layer is formed only to the reflective display area. For forming the retardation layer, patterning by using a photolithographic method of coating a retardation layer forming material comprising a liquid-crystalline acrylate monomer (described as an acrylated liquid crystal monomer, also) as a main ingredient and exposing the same through a photomask is adopted.

While the material that forms a retardation layer contains a polymerization initiator, the polymerization initiator tends to cause excess reaction to exposure and, when excess reaction is taken place, the pattern width of the cured retardation layer is greatly increased to more than a designed value, and it intrudes to the transmissive display area to lower the transflective display characteristic. This cannot cope with a demand for high fineness (number of pixels: 640×480 (VGA) in nominal 2 inch size). Further, as the pattern width of the retardation layer increases, a margin for positional alignment between a substrate and a mask is lowered upon exposure in the manufacturing step.

### SUMMARY OF THE INVENTION

The present invention intends to form a retardation layer so as to obtain a good display characteristic in a liquid crystal display device having a built-in retardation layer. That is, the invention intends to provide a transflection type liquid crystal display device capable of attaining a wide view angle comparable with that of the transmission type by forming a retardation layer within a margin of a designed pattern to a reflective display area thereby suppressing lowering of a transflective liquid crystal display characteristic.

It is considered that occurrence of excess reaction of the retardation layer forming material is caused by excessive progress of sequential radical reaction that causes excess curing during pattern exposure.

Then, in the invention, a liquid-crystalline acrylate monomer with addition of a photopolymerization initiator having a phosphine oxide structure that moderately releases radicals is used as the material for forming the retardation layer.

The invention provides a liquid crystal display device having, for example, a reflective display area and a transmissive display area, which includes;

a first substrate, a second substrate, a liquid crystal layer put between the first substrate and the second substrate, and a retardation layer that is housed between the first substrate and the second substrate, and in which the retardation layer is formed by polymerizing a liquid-crystalline acrylate monomer by using a photopolymerization initiator having a phosphine oxide structure.

In a case of a transflection type IPS system liquid crystal display device, the retardation plates (retardation layers) are disposed only to the reflective display area and the polarizer plates have a specification in common between the reflective display area and the transmissive display area. The polarizer plate is disposed for the entire surface of the upper surface and the lower surface of the first substrate and the second substrate constituting the liquid crystal panel, and the retardation plate is formed as a built-in retardation layer (in this case, the retardation layer is preferably disposed on the side of the inner display region excluding the opposed portion between the seal material and the first substrate). The built-in retardation layer is formed only to the reflective display area. In this case, transmissive display view angle characteristics identical with those of the transmission type IPS system are attained by disposing upper and lower polarizer plates in the same manner as in the transmission type IPS system (transmission axes are in perpendicular to each other, and one of them is in parallel with the aligning direction of the liquid crystals).

Further, the built-in retardation layer is disposed such that the phase difference between the reflective display area and the transmissive display area is shifted by ¼ wavelength after disposing the polarizer plate in the same manner as in the transmission type IPS system. Specifically, a multi-layer of the liquid crystal layer and the built-in retardation layer are arranged for a ¼ wavelength plate of a wide region. That is, retardation close to the reflection plate is formed as ¼ wavelength and retardation of the other is formed as ½ wavelength.

In the IPS system, alignment of the liquid crystal layer changes upon application of voltage such that the director direction mainly rotates within a layer, the change of the tilt angle is small and retardation changes scarcely. Accordingly, in the liquid crystal layer and the retardation layer, the liquid crystal layer is disposed so as to be close to the reflection electrode and the retardation thereof is defined as ¼ wavelength.

The retardation axis of the built-in retardation layer is determined as described below. That is, an azimuth is defined counterclockwise with the transmission axis of the upper polarizer plate as 0 degree. Assuming the azimuth of the retardation axis of the retardation layer as θPH and the azimuth for the aligning direction of the liquid crystal layer as θLC, the azimuth for a ¼ wavelength plate of a wide region is represented by the following equation (1).

2θPH=±45°+θLC equation (1)

In this case, since the arrangement of the polarizer plate in the transmissive display area is made identical with that of the transmission type IPS, θLC has to be either 0 degree or ±90 degree. Thus, θPH is ±22.5 degree (20 degree or more and 25 degree or less, with ±10% margin in view of manufacture) or ±67.5 degree (60 degree or more and 75 degree or less with +10% margin in view of manufacture). By arranging the multi-layer of the liquid crystal layer and the built-in retardation plate (retardation layer) as the ¼ wavelength plate of the wide region, the reflectance is lowered over the entire visible wavelength region, to obtain reflective display at low reflectance and with no color.

In the reflective display area and the transmissive display area, optimal values of liquid crystal layer retardation for making the reflectance and the transmittance to limit values defined by light absorption of the polarizer plate are different respectively and this is ¼ wavelength for the reflective display area and ½ wavelength for the transmissive display area. For attaining this, the thickness of the liquid crystal layer in the reflective display area has to be made smaller than that of the transmissive display area. Specifically, a thickness adjusting layer is disposed to the reflective display area and the thickness of the liquid crystal layer for the reflective display area is decreased by so much as the thickness of the thickness adjusting layer. The thickness adjusting layer has to be disposed so as to correspond to the reflective display area.

In the invention, the retardation plate is housed in the form of a retardation layer to the inside of the panel and the built-in retardation layer is disposed at a position corresponding to the reflective display area. The difference of the retardation necessary for the reflective display area and the transmissive display area is ¼ wavelength and the retardation necessary for the built-in retardation layer is ½ wavelength.

Accordingly, when the birefringence of the built-in retardation layer is lager by twice or more than that of the liquid crystal layer, the thickness of the retardation layer is less than the difference of the thickness of the liquid crystal layer required for the reflective display area and the transmissive display area. In this case, the retardation layer and the thickness adjusting layer are laminated and patterned so as to correspond to the reflective display area, such that the total thickness of both of the layers is a difference of the thickens of the liquid crystal layer necessary for the reflective display area and the transmissive display area.

Alternatively, when the birefringence of the retardation layer is twice as large as the liquid crystal layer, the thickness of the built-in retardation layer is equal with the difference of the thickness of the liquid crystal layer necessary for the reflective display area and the transmissive display area. Since the thickness adjusting layer is not necessary in this case, the production process can be simplified.

### BRIEF DESCRIPTION OF THE DRAWINGS

FIG. 1 is a plan view for explaining a constituent example of 1 pixel of a liquid crystal panel as a first embodiment;

FIG. 2 is a cross sectional view taken along line A-A in FIG. 1′;

FIG. 3 is an explanatory view for a process of manufacturing a liquid crystal panel;

FIG. 4 is a cross sectional view of a liquid crystal panel according to a second embodiment taken along A-A′ in FIG. 1; and

FIG. 5 is an explanatory view for a process of manufacturing a liquid crystal panel.

### DETAILED DESCRIPTION

The present invention is to be described by way of preferred embodiments with reference to the drawings.

### First Embodiment

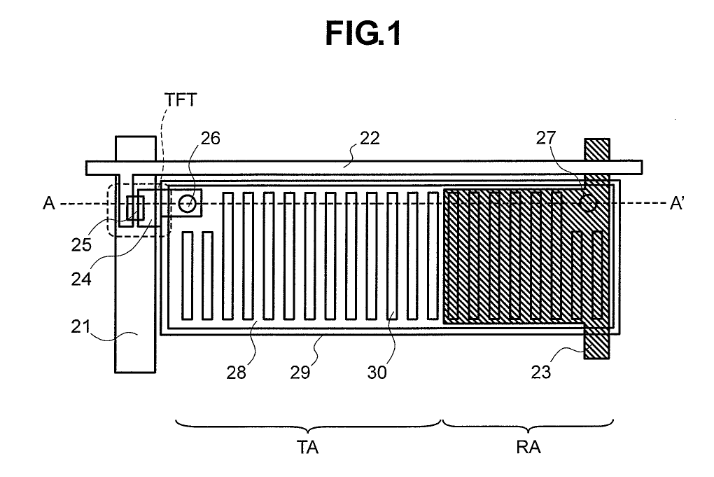

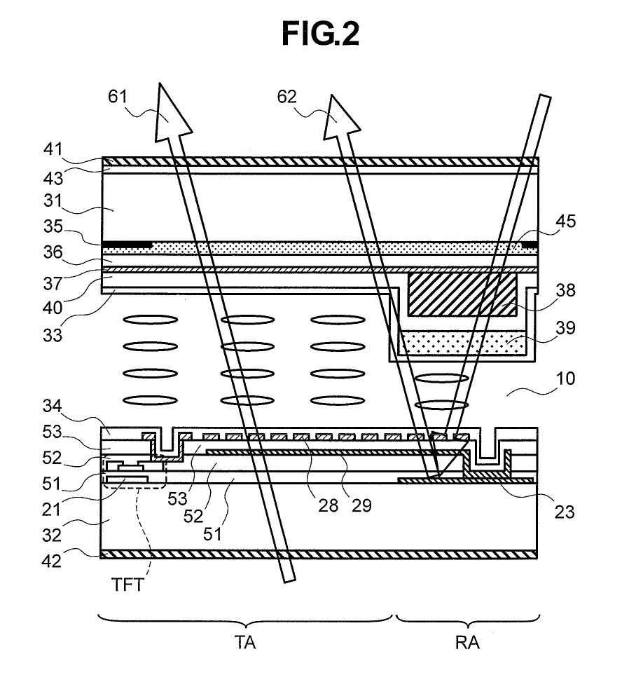

FIG. 1 is a plan view for explaining a constituent example of 1-pixel of a liquid crystal panel constituting a liquid crystal display device applied with the first embodiment. FIG. 2 is a cross sectional view taken along line A-A′ in FIG. 1 for explaining the schematic constituent example of 1-pixel of the liquid crystal panel shown in FIG. 1.

A liquid crystal panel includes a first substrate 31, a liquid crystal layer 10, and a second substrate 32, in which the liquid crystal layer 10 is sandwiched in an opposing space between the first substrate 31 and the second substrate 32.

On the main surface (inner surface) of the first substrate 31, are stacked a color filter 45 partitioned by a black matrix 35, a leveling layer (first protective film) 36, a third alignment film (alignment film for built-in retardation layer) 37, a built-in retardation layer (hereinafter simply referred to as a retardation layer) 38, a protective layer (second protective film) 40 for the retardation layer 38, and a first alignment film 33 in this order.

The retardation layer 38 is disposed only to a reflective display area RA, and is not disposed to a transmissive display area TA.

The third alignment film 37 is provided with an alignment control function of controlling the alignment of a material that forms the retardation layer 38 comprising a liquid crystal layer composition. Further, the first alignment film 33 is provided with an alignment control function of controlling the initial alignment of the liquid crystal layer 10 for display light control.

The main surface of the second substrate 32 has a thin film transistor TFT for driving the pixel. The thin film transistor TFT is connected to a scanning interconnection 21, a signal interconnection 22, and a pixel electrode 28.

In addition, the second substrate 32 has a common interconnection 23 and a common electrode 29. The thin film transistor TFT has a reverse staggered structure in which a channel part is formed of an amorphous silicone (a-Si) layer 25. The scanning interconnection (gate) 21 and a source-drain electrode 24 are insulated by a first insulation layer 51. A second insulation layer 52 is present above the thin transistor TFT.

The scanning interconnection 21 and the signal interconnection 22 intersect in the row direction and the column direction to form a 2-dimensional matrix. The thin film transistor TFT is situated near the intersection of the interconnections.

The common interconnection 23 is disposed in parallel with the scanning interconnection 21 and connected by way of a second through hole 27 to the common electrode 29. The pixel electrode 28 and the source drain electrode 24 of the thin film transistor TFT are bonded by way of a first through hole 26. A second alignment film 34 is present above the pixel electrode 28 and is provided with an alignment control function of controlling the initial alignment of the liquid crystal layer 10.

The first substrate 31 is preferably formed of borosilicate glass with less ionic impurities and the thickness thereof is, for example, 0.5 mm. In the color filter 45 partitioned by the black matrix 35, each of the portions showing red, green and blue (color sub-pixels) are repetitively arranged in a stripe manner and each of the strips is in parallel with the signal electrode 22. Crenelation on the surface of forming the black matrix 35 and the color filter 45 is leveled by a leveling layer (first protective film, overcoat film) 36 made of resin. The first alignment film 33 is a polyimide organic film, and is applied with an aligning treatment by a rubbing method.

For the second substrate 32, borosilicate glass like that for the first substrate 31 is suitable and the thickness is, for example, 0.5 mm. The second alignment film 34 is an organic polyimide film having a horizontally aligning property like the first alignment film 33. The signal interconnection 22, the scanning interconnection 21, and the common interconnection 23 are formed, for example, of aluminum, (Al) or an alloy thereof (aluminum and neodium alloy: Al—Nd), or chromium (Cr). The pixel electrode 28 is preferably formed of a transparent conductive film such as of indium tin oxide (ITO) and the common electrode 29 is also formed preferably of a transparent conductive film such as of ITO.

The pixel electrode 28 has slits 30 parallel with the scanning interconnection 21 and the pitch between the slits 30 is about 4 μm. The pixel electrode 28 and the common electrode 29 are spaced by a third insulation layer 53 of 0.5 μm thickness and an electric field is formed between the pixel electrode 28 and the common electrode 29 upon application of voltage. The electric field is deformed into an arc-shape by the effect of the third insulation layer 53 and passes through the liquid crystal layer 10. This changes alignment of the liquid crystal layer 10 upon application of voltage. Numerical values described above also including other numerical values in the specification and the drawings are shown only as examples and the invention is not restricted to the numerical values.

The common interconnection 23 has a structure extending into the pixel electrode 28 in the area crossing the pixel electrode 28. In FIG. 1, an area where the common interconnection 23 and the pixel electrode 28 overlap is a reflective display area RA and reflects light as shown by a reflection light 62. Other overlapped area between the pixel electrode 28 and the common electrode 29 than described above allows the light of a backlight to transmit therethrough to form a transmissive display area TA as shown by a transmission light 61. Since the optimal layer thickness of the liquid crystal layer is different between the transmissive display area TA and the reflective display area RA, a step is formed at the boundary. For shortening the boundary between the transmissive display area TA and the reflective display area RA, the transmissive display area TA and the reflective display area RA are arranged such that the boundary is in parallel with the shorter side of the pixel.

As described above, by using the interconnections such as the common interconnection 23 in common with the reflection plate, an effect of decreasing the manufacturing steps can be obtained. When the common interconnection 23 is formed of aluminum or the like of high reflectance, brighter reflective display is obtained. The same effect is obtained also by forming the common interconnection 23 with chromium and separately forming a reflection plate of aluminum or a silver alloy.

The liquid crystal layer 10 comprises a liquid crystal layer composition that shows a positive dielectric constant anisotropy in which the dielectric constant in the aligning direction is greater than that in the normal direction. In this case, the birefringence of the composition is 0.067 at 25° C. and shows a nematic phase in a wide temperature range including a room temperature region. Further, the liquid crystal layer shows a high resistance value not causing flicker by sufficiently maintaining reflectance and transmittance during holding period when driven at a frequency of 60 Hz by using the thin film transistor.

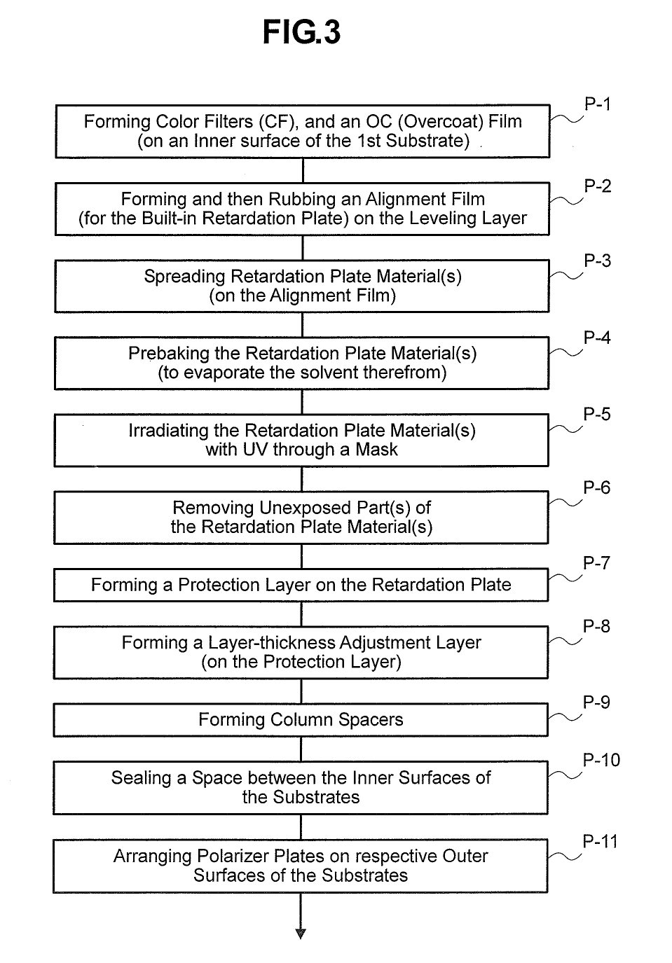

Then, a manufacturing process for the liquid crystal panel constituted as descried above is to be described with reference to FIG. 3.

At first, the black matrix 35 and the color filter 45 are formed on the main surface of the first substrate 31, and the surface is covered and leveled by the first protective film 36 (P-1). The alignment film (third alignment film) 37 for the retardation layer is coated on the first protection film 36, and rubbed to provide an alignment control function (P-2). The third alignment film 37 has a horizontal aligning property and has a function of determining the direction of the retardation axis of the retardation layer 38.

Then, a material for forming the retardation layer is coated on the third alignment film 37 (P-3). The ingredient of the material for forming the retardation layer has to be selected properly in order to prevent coloration of the retardation layer 38 and prevent “increase” in the width by excess (suddenly) polymerizing reaction.

In this embodiment, an organic material formed by dispersing one or more photopolymerization initiators (reaction initiators) having a phosphine oxide structure in an organic solvent is used for a nematic liquid crystal monomer having photoreactive acrylic group (acrylate) at the terminal end of the molecule (hereinafter referred to as “liquid-crystalline acrylate monomer (also described as acrylated liquid crystal monomer)”).

The liquid-crystalline acrylate monomer may be selected properly in accordance with required Δn.

Examples of the liquid-crystalline acrylate monomers are shown according to the following “chemical formula 1” and “chemical formula 2”.

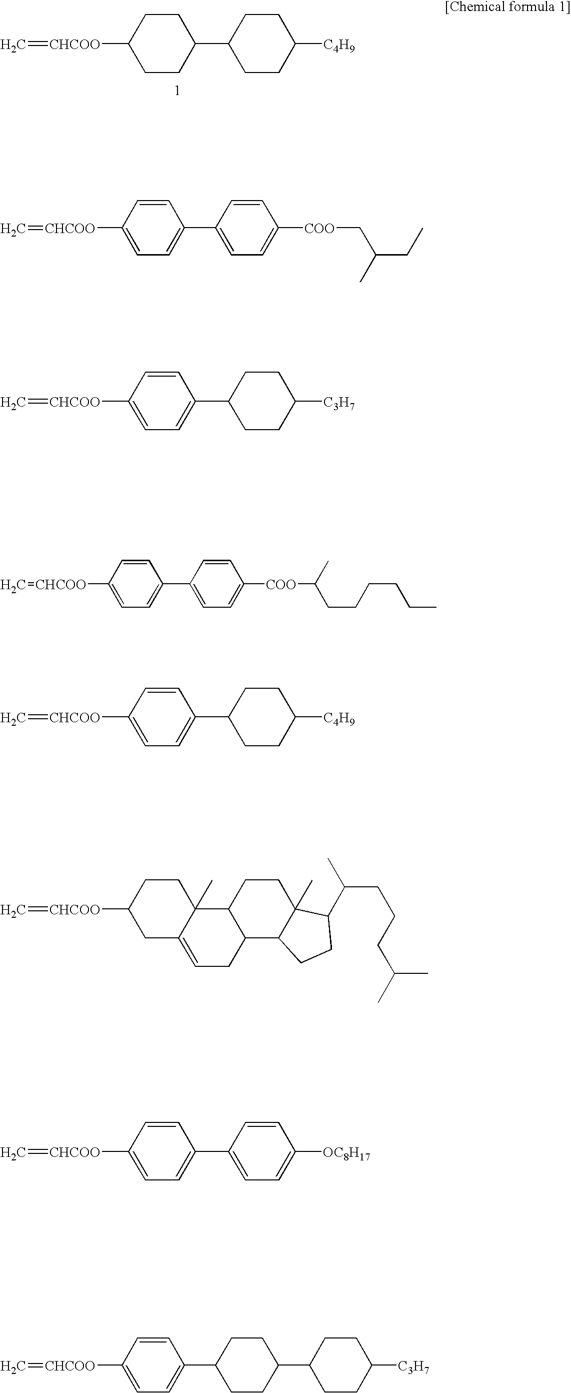

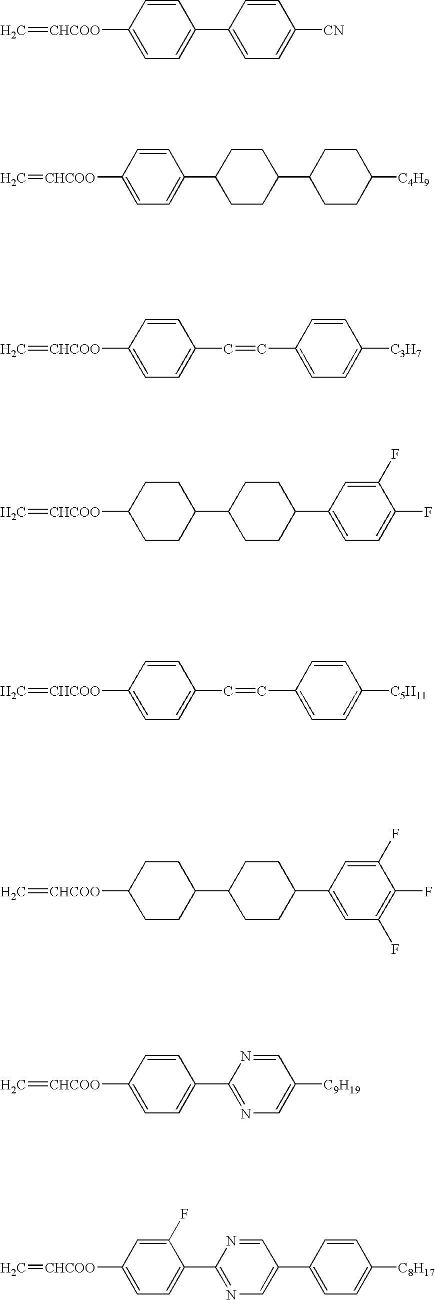

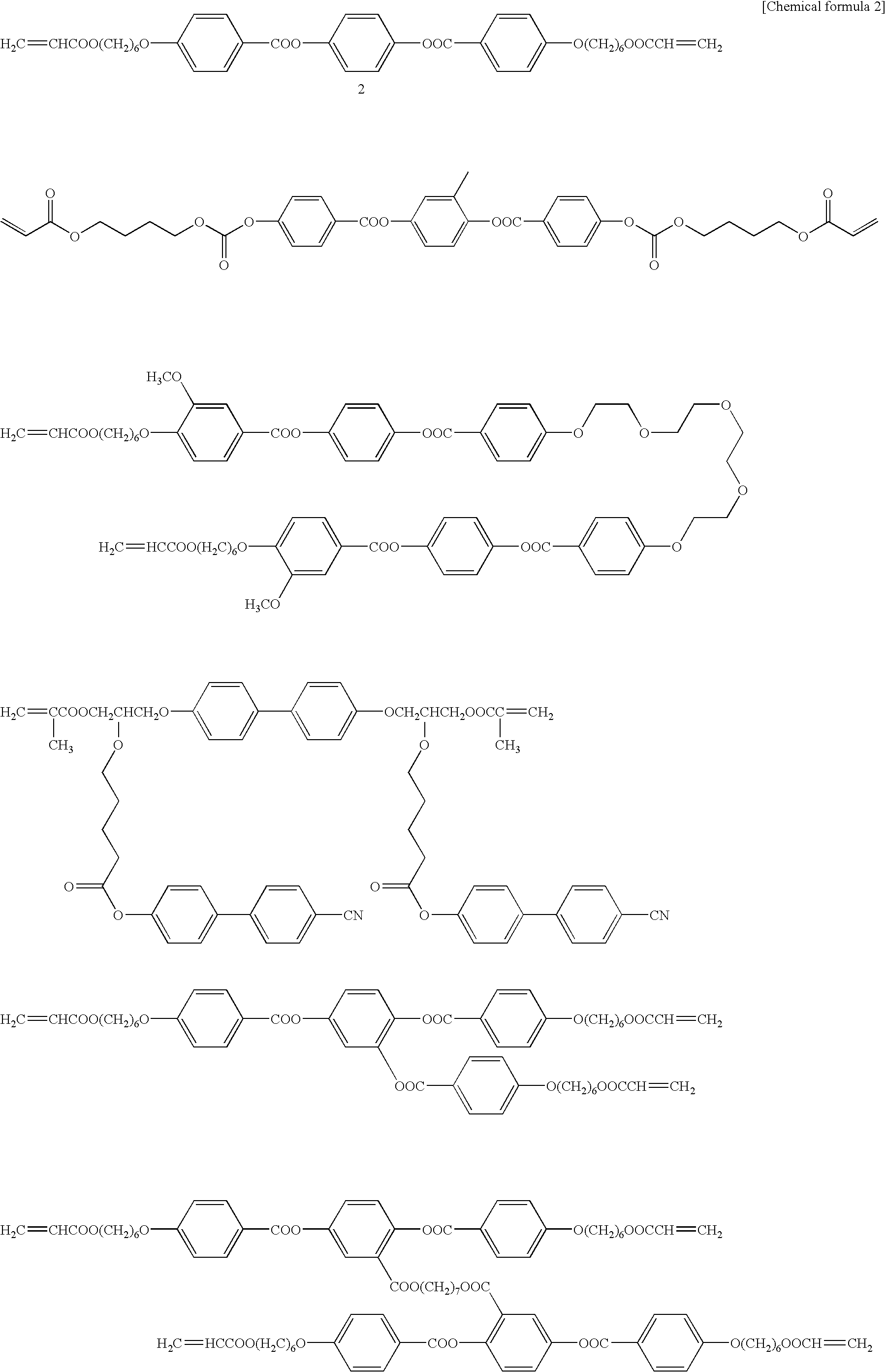

By properly selecting the liquid-crystalline acrylate monomer, the photopolymerization initiator and the wavelength of a light to be irradiated, it is possible to suppress coloration of the retardation layer 38 to be formed and prevent “increase” of the retardation layer 38 by excess polymerization.

In this embodiment, a phosphine oxide type photopolymerization initiator is used. By using the phosphine oxide type photopolymerization initiator, the transmittance of the retardation layer 38 can be made within a range of 95% or higher relative to visible light (for example, light at a wavelength within a range from 400 nm to 800 nm) to prevent coloration.

Further, by using the phosphine oxide type photopolymerization initiator, excess polymerization of the liquid crystal monomer can be suppressed to prevent “increase” of the retardation layer 35.

The following “chemical formula 3” shows, as the example of the photopolymerization initiator having the phosphine oxide structure, 2,4,6-trimethyl benzoyl diphenyl phosphine oxide, bis(2,4,6-trimethyl benzoyl)-phenyl phosphine oxide, bis(2,6-dimethoxybenzoyl)-2,4,4-trimethyl pentyl phosphine oxide. They can be commercially available as IRGACURE 819, DAROCURE TPO, and IRGACURE 1800 (1870) manufactured by Ciba Specialty Chemicals, respectively.

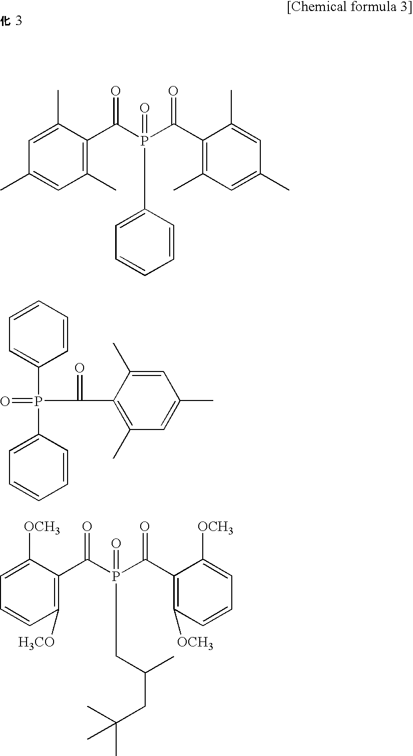

With an aim of improving the wettability, it is effective to add from 0.01 to 0.3% of a leveling agent to the material for forming the retardation layer. The leveling agent usable herein includes, for example, BYK-302, BYK-306, BYK-307, BYK-330, BYK-352, BYK-354, BYK-356, BYK-361N, BYK-370, and BYK-390, manufactured by BYK-Chemie Japan, Osaka, Japan, Flow 300, Flow 425, Flow ZFS 460, Glide 100, Glide 410, Glide 420, Glide 435, Glide A115, and Glide ZG 400, manufactured by Tego.

The organic solvent usable herein includes, for example, propylene glycol monomethyl ether acetate, cyclohexanone, ethylene glycol monomethyl ether acetate, diethylene glycol monobutyl ether acetate, diethylene glycol monoethyl ether acetate, 3-methoxy butyl acetate, diethylene glycol dimethyl ether, and diethylene glycol methylethyl ether.

After coating the material for forming the retardation layer, it is prebaked for 2 to 3 minutes by a hot plate or the like at 100° C. to remove the solvent (P-4). Thus, a transparent film is formed. The film is aligned directing to the direction of the aligning treatment of the third alignment film 37 at the time of prebaking and is provided with a function as a retardation plate.

UV light is irradiated to the prebaked material for forming the retardation layer, at an area corresponding to the reflective display area RA through an exposure mask having an opening corresponding to the pattern of the retardation layer 38 and the acrylic group is photopolymerized and cured to form the retardation layer 38 (P-5). By the mask exposure, acrylate corresponding to the opening of the exposure mask is polymerized to form a film insoluble to an organic solvent. In this case, the film thickness is adjusted by properly controlling the solution concentration and the coating condition during coating such that the retardation of the retardation layer 38 is ½ wavelength at a wavelength of 550 nm.

Then, development is conducted with an organic solvent and a not exposed portion is removed (P-6).

Then, a transparent organic layer is coated on the retardation layer 38 to form a second protection layer 40 (P-7). Further, the thickness adjusting layer 39 is formed only above the retardation layer 38 (P-8). Specifically, a photosensitive transparent resist is at first coated to the second protection layer 40 and exposed to UV-light by using an exposure mask. In this case, patterning is conducted by using an exposure mask so as to provide the same distribution as the reflective display area RA. Then, when alkali development is conducted, the film thickness adjusting layer 39 is formed only above the retardation layer 38.

The reason of disposing the thickness adjusting layer 39 is as described below. When the retardation layer 38 having Δn as large by twice or more than that of as the liquid crystal layer is used, the thickness becomes insufficient when the retardation of the retardation layer 38 is set to ½ wavelength, and the difference of retardation between the reflective display area RA and the transmissive display area TA is less than ¼ wavelength only by the retardation layer 38. In view of the above, by forming the thickness adjusting layer 39 above the retardation layer 38, a retardation difference of ¼ wavelength is ensured between the reflective display area and the transmissive display area.

Then, after coating the first alignment film 33 to the uppermost layer of the main surface of the first substrate 31 and the second alignment film 34 to the uppermost surface of the main surface of the second substrate 32, and applying a rubbing treatment in the direction so as to intersect to each other at a predetermined angle, column spacers are interposed to the display region between the first substrate 31 and the second substrate 32 (P-9), a sealing material is coated to the inside of the outer peripheral edge, both of the substrates are assembled by bonding to each other, and the liquid crystal layer 10 is sealed to the inside (P-10).

Finally, a first polarizer plate 41 and a second polarizer plate 42 are arranged to the outside of the first substrate 31 and the second substrate 32 respectively (P-11). In this case, the transmission axis of the first polarizer plate 41 and that of the second polarizer plate 42 are arranged such that they are in perpendicular and in parallel to the aligning direction of the liquid crystal layer, respectively.

The manufacturing process of the liquid crystal panel is as has been described above.

In the liquid crystal panel described above, a light diffusing pressure sensitive adhesive layer 43 formed by incorporating, to the inside thereof, a number of transparent fine spheres having a refractive index different from a pressure sensitive adhesive material was used as the pressure sensitive adhesive layer 43 of the first polarizer plate 41. The constitution described above has an effect of diffusing the optical path of the incident light by utilizing the effect of refraction at the boundary between the pressure sensitive adhesive material and the fine spheres due to the difference of the refractive index between both of them. This can reduce iridescent coloration caused by the interference of reflection light in the pixel electrode 28 and the common electrode 29. However, it will be apparent that the pressure sensitive adhesive layer 43 is not restricted only to such a constitution but a pressure sensitive adhesive material having no fine spheres can also be used.

As in this embodiment, when the material for forming the retardation layer with addition of the phosphine oxide photopolymerization initiator is used, increase in the pattern width of the retardation layer 38 is restricted to such an extent that it is larger by about 3 to 5 μm than the designed width of the mask opening. Accordingly, it is also possible to make the finest portion of the pattern width to 20 μm or less. Then, the reproducibility of the photomask can be improved and high refinement of the liquid crystal panel can be attained. Further, in the manufacturing step, the margin for the positioning accuracy upon pattern exposure is increased and product failure attributable to misalignment in the exposure is decreased.

The usefulness of the phosphine oxide photopolymerization initiator is to be described with reference to a comparative example. In the comparative example, a general-purpose photopolymerization initiator, for example, IRUGACURE (R) 907, IRUGACURE 369, manufactured by Ciba Specialty Chemicals, or 2-(3,4-metehylene dioxyphenyl)-4,6-bis(trichloromethyl)-1,3,5-triazine was used.

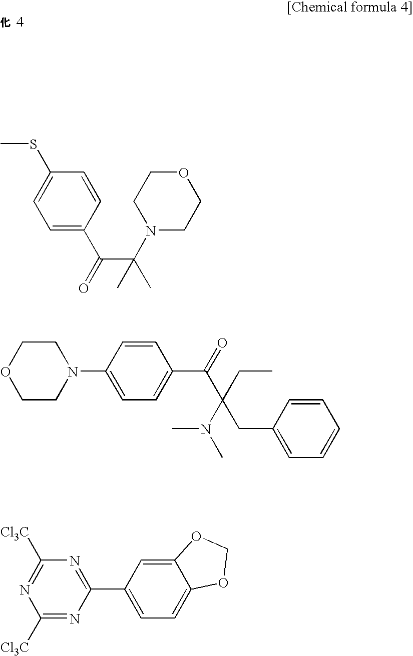

In a case of adding one or more photopolymerization initiator selected from those described above, it is considered that the polymerization rate is high and the degree of polymerization is high, and the pattern is cured excessively to more than the width (size) of the mask opening upon pattern exposure, and the pattern width after development increases to more than the width of the mask opening by about 10 to 15 μm. On the other hand, in a case of using the opening mask of about 5 μm, the difference of the film thickness becomes remarkable between a portion just below the opening and an excessively cured portion making the in-plane thickness not uniform. Accordingly, it is difficult to form a pattern width of 20 μm or less. Further, since the photopolymerization initiator including the residues remains to the inside of the phase difference material even after the completion of the reaction, it is difficult to increase the transmittance of the retardation layer 38 to 95% or higher to a visible light (light at a wavelength within a range from 400 nm to 800 nm) and it is usually within a range of 90% or less and coloration of the layer cannot be suppressed.

On the other hand, it is known that the phosphine oxide photopolymerization initiator has a photobleaching function and since it does not cause coloration attributable to the photopolymerization initiator, the transmittance of the retardation layer 38 can be made within a range of 95% or higher to the visible light (light at a wavelength of 400 nm to 800 nm) and coloration of the retardation layer 38 can be suppressed.

In this embodiment, since the retardation layer 38 comprises a liquid crystal polymer, the aligning property of the molecules is higher compared with that of existent external retardation plates prepared by stretching an organic polymeric film and it has an aligning property about equal with that of the liquid crystal layer 10. Accordingly, Δn of the retardation layer 38 is much more greater than that of the external retardation plate and it can be made about identical with or more than that of the liquid crystal layer 10 when the molecular structure and the film forming condition are controlled properly. The thickness of the external retardation plate is as large as several tens μm, which is about 10 times as large as the thickness of the liquid crystal layer. However, when a built-in retardation layer is formed by using the liquid crystal polymer, the thickness of the retardation layer 38 can be decreased greatly and can be made thinner than the step between the reflective display area and the transmissive display area. Thus, particular leveling is no more necessary when the retardation layer 38 is patterned conforming to the reflective display area.

The transflective type liquid crystal panel manufactured as described above was connected to a driving device, a backlight was disposed at the back to constitute a liquid crystal display device, and the display state was observed. When it was observed in a light place in a state of putting off the backlight, display images by reflective display could be confirmed. Then, when the display state was observed in a dark place in a state of putting on the backlight, display images by transmissive display could be confirmed. Even when the observing direction relative to the normal to the substrate was changed for a wide range, contrast reversal did not occur and the contrast ratio was less lowered.

Further, in the liquid crystal display device of this embodiment, a retardation layer material with less adhesion to the sealing material is not present between the sealing material and the first substrate 31. Accordingly, the first substrate 31 and the second substrate 32 are secured firmly, and displacement or defoliation of both of the substrates caused by application of an external force can be avoided to obtain overall environment type display device of fast structure.

In the transmissive display area TA of the transflective liquid crystal display device comprising the liquid crystal panel manufactured as described above, the transmission axis of the first polarizer plate 41 and the transmission axis of the second polarizer plate 42 are perpendicular to each other and the latter is in parallel with the aligning direction of the liquid crystal layer. Since this is the same constitution as the transmission type IPS system, a wide view angle suitable for monitor use is obtained for the transmissive display in the same manner as in the transmission type IPS system.

On the other hand, the reflective display area RA includes a homogeneously aligned liquid crystal layer 10, a retardation layer 38 and a first polarizer plate 41. The mutual relation among the retardation axis of the retardation layer 38, the aligning direction of the liquid crystal layer and the angle of transmission axis of the first polarizer plate 41 is as described below. That is, since the slits 30 of the pixel electrode 28 shown in FIG. 1 are vertical to the signal interconnection 22, the direction of the electric field is in parallel with the direction of the signal interconnection 22. When the azimuth is defined counterclockwise, the aligning direction of the liquid crystal layer is −75° relative to the direction of the electric field and this can provide an effect of stabilizing the change of alignment upon application of voltage and decreasing threshold voltage causing the change in alignment. The direction of the retardation axis of the retardation layer 38 and the transmission axis of the first polarizer plate 41 are 67.5° and 90° to the aligning direction of the liquid crystal layer respectively.

Further, since the retardations of the liquid crystal layer 10 and the retardation layer 38 in the reflective display area RA are defined as ¼ wavelength and ½ wavelength respectively, a multi-layer of the crystal layer 10, the retardation layer 38, and the first polarizer plate 41 in the reflective display area RA form a circular polarizer plate for a wide region. When the voltage is not applied, an incident light enters the reflection plate in a state of circular polarization or a polarization state approximate thereto substantially over the entire region of visible wavelengths. After reflection, when the light is again incident to the first polarizer plate 41, since it forms a linearly polarized light with the oscillation direction being parallel to the absorption axis of the first polarizer plate, dark display with no color can be obtained.

The equation (1) described above for determining the azimuth of the retardation axis of the retardation layer 38 and the retardation of the retardation layer 38 and the liquid crystal layer 10 are derived as below by using the Poincare Sphere representation. The Poincare Sphere representation is defined in a space with Stoke's parameters (S1, S2, S3) describing the polarized state being as three axes, and each point on the Poincare Sphere is in one-to-one correspondence to the polarized state. For example, lines of intersection with (S1, S2) planes (equator) on the Poincare Sphere correspond to linearly polarized light, intersections with the S3 axis (North and South poles) correspond to circularly polarized light, and others correspond to elliptically polarized light.

Further, (S1, S2, S3) are represented by the following equations (2), (3) and (4) using arbitrary X-axis component Ex, arbitrary Y-axis component Ey, and phase difference δ between Ex and Ey of electric vectors respectively:

S1=(Ex²−Ey²)/(Ex²+Ey²) equation (2)

S2=2E×Ey cos δ/(Ex²+Ey²) equation (3)

S3=2E×Ey sin δ/(Ex²+Ey²) equation (4)

Conversion of the polarized state by the retardation layer 38 and the liquid crystal layer 10 with no deflection are contained within (S1, S2) planes on the Poincare Sphere and is represented as rotation around a line passing the center of the Poincare Sphere. The angle of rotation in this case is ½ rotation when the retardation of the retardation plate is ½ wavelength and ¼ rotation when it is ¼ wavelength.

It is to be noted on a process where a typical wavelength, in a visible light region, for example, an incident light at a wavelength of 550 nm at which human visibility is at the highest passes through the first polarizer plate 41, the retardation layer 38, and the liquid crystal layer 10 for the reflective display area RA successively, and reaches the pixel electrode 28 or the common electrode 29.

For the sake of explanation, assuming the Poincare Sphere as a glove, and intersections with the S3 axis as North pole and South pole and lines of intersection with (S1, S2) planes as an equator, the incident light formed into a linearly polarized light by the first polarizer plate 41 situates at the equator on the Poincare Sphere, the azimuth is rotated by ½ rotation around the axis of rotation as the center by the retardation plate 38 to move to another point on the equator, and light then converted into a linearly polarized light of different oscillating direction. Then, the azimuth is rotated by ¼ around the rotary axis of rotation by the liquid crystal layer 10 and moves to the North pole, that is, it is converted into a circularly polarized light.

Then, taking notice on incident light at other wavelengths than descried above, retardation has a wavelength dependency and retardation is larger toward the shorter wavelength side and smaller toward the longer wavelength side both in the phase retardation layer and in the liquid crystal layer. Accordingly, the angle of rotation is different depending on the wavelength and, in the rotation by the retardation layer 38, the light at a wavelength other than 550 nm does not conduct ½ rotation but moves to a point out of the equator. Since a blue light on the shorter wavelength side has retardation larger than ½ wavelength, it is rotated by more than ½ rotation to move to a position out of the equator. Since the red light on the longer wavelength side has retardation smaller than ½ wavelength, it is rotated by ½ rotation or less to move to a position out of the equator.

However, since the moving direction is substantially opposite in the rotation by the liquid crystal layer 10 that occurs succeedingly, difference of the angle of rotation due to the wavelength caused in the retardation layer 38 is compensated. That is, while the blue light on the shorter wavelength side is rotated by more than ¼ rotation also in the liquid crystal layer 10, since it starts movement from a position on the South hemisphere, it reaches a position just above the North pole. A red light on the longer wavelength side is rotated by less than ¼ rotation also in the liquid crystal layer 10. Since it starts movement from a position on the North hemisphere, it reaches a position just above the North pole by the rotation of less than ¼ rotation. As a result, lights at respective wavelengths concentrate near the North pole, and lights at respective wavelengths are formed each into a substantially identical circularly polarized light. When this is observed as a display state of the liquid crystal layer, a dark display with no color lowered with the reflectance is obtained in a wide region of the visible wavelength. When an additional line is drawn so as to extend the direction of ¼ rotation, the additional line is in perpendicular to the aligning direction of the liquid crystal layer representing the center of rotation (azimuth θ′LC). Further, the direction of the retardation axis (azimuth θ′PH) of the built-in retardation plate representing the center of ½ rotation equally bisects the angle between the S1 axis and the additional line. The angle equally bisecting the angle between the S1 axis and the additional line is: θ′ PH-180° and since θ′LC-180° is equal with (θ′PH-180°)×2+90°, the following equation (5) is determined.

2θ′PH=90°+θ′LC equation (5)

While incident lights at respective wavelengths are concentrated to the North pole NP on the Poincare Sphere, the same effect can be obtained also by concentrating the incident lights to the South pole SP of the Poincare Sphere. In this case, the relation between θ′PH and θ′LC is represented by the following formula (6).

2θ′PH=−90°+θ′LC equation (6)

Further, for concentrating incident lights at respective wavelengths to the North pole NP or the South pole SP, the relation between θPH and θ′LC are represented, additionally by the equations (5) and (6) respectively. That is, since 360°−θ′LC is equal with (360°−θ′PH)×2+90°, 2 θ′PH=360°+90°+θ′LC, it is represented by the equation (5). Further, since 180°−θ′LC is equal with (180°−θ′PH)×2+90°, 2 θ′PH=360°−90°+θ′LC and this is represented by the equation (6).

The axis of rotation on the Poincare Sphere corresponds to the azimuth θPH and θLC of the retardation axis and the azimuth of the axis of rotation is twice the azimuth of the retardation axis in a real space (θ′PH=2θPH, θ′LC=2θ′LC). By substituting the same into the equations (5), (6), the equation (1) representing the relation between the built-in retardation plate and the azimuth of the retardation axis of the liquid crystal layer is determined.

In the first embodiment, for making the view angle characteristic of the transmissive display equal with that of the transmission type IPS, arrangement for the polarizer plate in the transmissive display area TA is made equal with that in the transmission type IPS system. Accordingly, it is set as: θLC=90 degree. When this is substituted in the equation (1) and a negative sign is selected, θPH=22.5 degree, and the azimuth of the retardation axis in the retardation layer is determined. Since details for the setting of the azimuth of the retardation axis of the retardation layer described above are disclosed in JP-A No. 2005-338256, no further descriptions are to be made.

### Second Embodiment

A second embodiment of the invention is to be described.

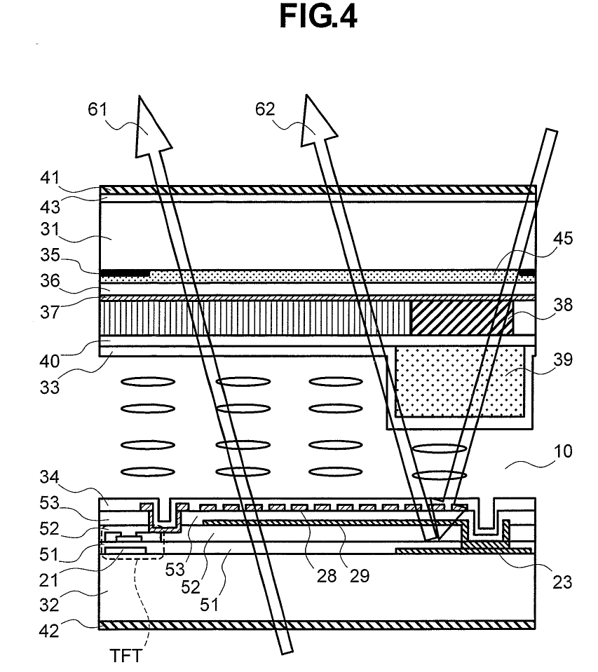

FIG. 4 is a cross sectional view of a liquid crystal panel according to a liquid crystal display device of a second embodiment. This corresponds to a cross sectional view of FIG. 1 along line A-A′. The liquid crystal display device of this embodiment is different from the liquid crystal display device of the first embodiment with respect to the retardation layer 38. Since other constitutions are identical with those in the first embodiment, descriptions therefor are to be omitted.

In the first embodiment described above, for forming the retardation layer 38, the material for forming the retardation layer was coated over the entire surface of the third alignment film 37 on the leveling layer 36, only the reflective display area RA was selectively cured by mask exposure, and the uncured portion of the transmissive display area TA was removed by development using an organic solvent. In this embodiment, the uncured portion of the transmission area TA was cured by heating and the phase difference property is eliminated. It is not removed but left as a transparent layer 38n.

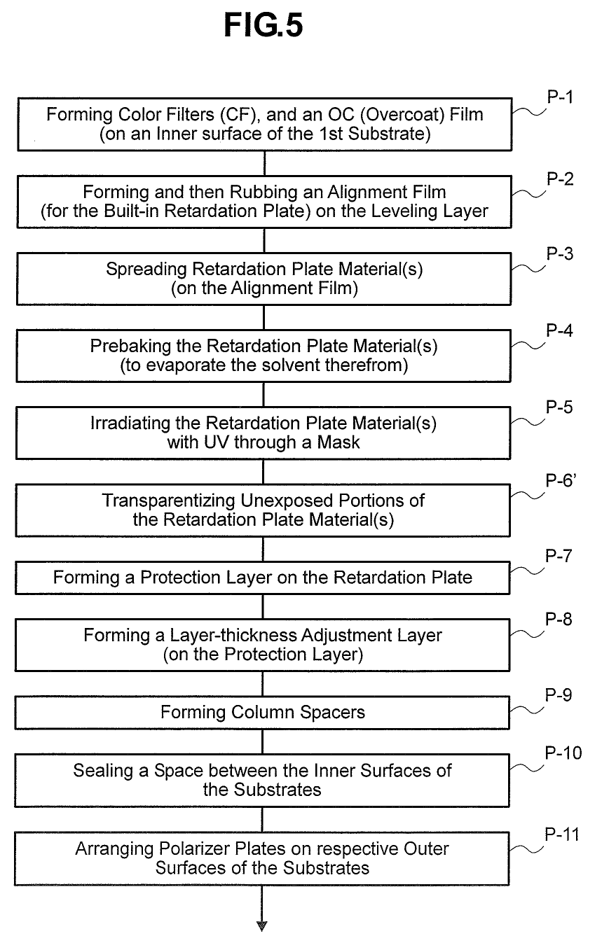

FIG. 5 is a view showing the manufacturing process of a liquid crystal panel constituting the liquid crystal display device of this embodiment.

After forming a third alignment film 37 over the entire surface of a first substrate 31, it is rubbed to provide an alignment control function (P-2). The third alignment film 37 has a horizontally aligning property and has a function of determining the direction of the retardation axis of a retardation layer 38.

Then, a material for the retardation layer is coated on the third alignment film 37 (P-3). In this case, as the material for the retardation layer, an organic material formed by dispersing a polymerization initiator (reaction initiator) having a phosphine oxide structure into an organic solvent is used as a nematic liquid crystal monomer having a photoreactive acrylic group (acrylate) at the molecular terminal end like in the first embodiment described above.

The liquid-crystalline acrylate monomer as the material for forming the retardation layer and the polymerization initiator having the phosphine oxide structure are as shown in the first embodiment.

Then, a relation between the polymerization initiator and a light to be irradiated is to be described. The liquid crystal substance for forming the retardation layer 38 usually results in coloration when absorbing a light at a wavelength of less than 300 nm. Accordingly, it is preferred that a light at a wavelength of less than 300 nm is not irradiated.

For this purpose, a lamp capable of irradiating a light at a specified wavelength is used. For example, a Black light-Blue (BL-B) fluorescent lamp is used preferably. The Black light-Blue fluorescent lamp mainly emits a near-ultraviolet light (nominal wavelength region of 300 to 400 nm) and it shows a peak wavelength, for example, at 360 nm.

Alternatively, a filter of cutting off light at wavelength of less than 300 nm may be used. For example, a short wavelength cut-off UV ray filter for cutting off short wavelength light can be used. Further, a filter capable of cutting off all absorption wavelength of a liquid crystal substance forming the retardation plate may also be used. As an example, Teijin Tetron film G2 (trade name of product) manufactured by Teijin Dupont Film Co. can be used.

As described above, for irradiating a light at 300 nm or more by selecting the lamp or the filter, it is necessary that the material for forming the phase difference is cured by the irradiation of a light at a wavelength of 300 nm or more. A photopolymerization initiator showing absorbance at 300 to 400 nm is selected. Preferred photopolymerization initiators are those having a light absorption coefficient in methanol as a solvent is within a range of 1000 ml/g cm or more at 365 nm and 100 ml/g cm or more at 405 nm.

As described above, by property selecting the material for the retardation plate, the photopolymerization initiator, and the wavelength of the light to be irradiated, the transmittance of the retardation layer 38 and the transparent layer 38n can be made within a range of 95% or more for the visible light (light at a wavelength within a range from 400 nm to 800 nm), respectively, and coloration thereof can be suppressed.

After coating the material for forming the retardation layer, this is prebaked for 2 to 3 minutes, for example, by a hot plate at 100° C. to eliminate a solvent (P-4), thereby forming a transparent film. The film is aligned directing to the alignment treating direction of the third alignment film 37 at the time of prebaking and is provided with a function as the retardation plate.

To the prebaked material for forming the retardation layer, UV-light (preferably, light at a wavelength of less than 300 nm is cut as described above) is irradiated to a portion corresponding to the reflective display area RA by using an exposure mask having an opening corresponding to the pattern of the retardation layer 38 to be formed, the acrylic group is photopolymerized and cured to form the retardation layer 38 (P-5). By the mask exposure, acrylate corresponding to the opening of the exposure mask is polymerized and functions as the retardation plate. In this case, the film thickness is adjusted by properly controlling the solution concentration and the coating condition during coating, such that retardation of the retardation layer 38 is adjusted to ½ wavelength at a wavelength of 550 nm.

Then, by heating the first substrate entirely to or higher than the nematic-isotropic transition temperature of the liquid crystal monomer as the material for forming the retardation layer, the phase difference property at an uncured portion corresponding to the non-opening area of the exposure mask is eliminated. The uncured acrylic group situating at the non-opening area of the exposure mask is photopolymerized by applying lamp exposure over the entire surface in a heated state of eliminating to form the transparent layer 38n the phase difference property, and it is cured in a state where the phase difference property is eliminated (P-6′).

The lamp for entire surface exposure may be UV-fluorescent lamps of about 20 W arranged in parallel but it is preferred to use Black light-Blue (BL-B) fluorescent lamps as a sort of such exposure lamps. The Black light-Blue fluorescent lamp mainly emits near-ultraviolet light (nominal wavelength region: 300 to 400 nm) and shows a peak wavelength, for example, at 360 nm.

Since the retardation layer 38 comprises a liquid crystal polymer, it has a higher alignment property of molecules compared with existent external retardation plates prepared by stretching an organic polymeric film and has an alignment property about equal with that of the liquid crystal layer 10. Further, the transparent layer 38n is optically transparent and Δn is 0. However, Δn of the retardation layer 38 situating in an identical layer is much more greater than that of the external retardation plate and can be made substantially equal with or more than that of the liquid crystal layer 10 by properly controlling the molecular structure and the film forming condition. While the thickness of the external retardation plate is large as several tens μm, which is nearly about 10 times as large as the thickness of the liquid crystal layer, when it is formed as a built-in retardation layer by using the liquid crystal polymer, the thickness of the retardation layer 38 can be decreased greatly and, further, a step between the reflective display area RA and the transmissive display area TA is eliminated.

Then, a transparent organic layer is coated on the retardation layer 38 to form a second protection layer 40 (P-7). Then, a photosensitive transparent resist is coated to the second protection layer 40 and UV-exposure is applied by using an exposure mask. In this case, pattering is conducted by using an exposure mask so as to obtain the same distribution as that in the reflective display area. Then, a thickness adjusting layer 39 is formed only to the layer above the retardation layer 38 by alkali development (P-8).

When a retardation layer 38 having Δn larger by more than twice of the liquid crystal layer is used, the thickness is insufficient when the retardation of the retardation layer 38 is set to ½ wavelength and the difference of retardation between the reflective display area RA and the transmissive display area TA is less than ¼ wavelength only by the retardation layer 38. Then, by forming the thickness adjusting layer 39 above the retardation layer 38, retardation difference of ¼ wavelength is ensured between the reflective display area and the transmissive display area.

Then, after coating a first alignment film 33 to the uppermost layer of the main surface of the first substrate 31 and a second alignment film 34 to the uppermost surface of the main surface of the second substrate 32, and applying a rubbing treatment in the direction such that they intersect to each other at a predetermined angle, column spacers are interposed to the display region between the first substrate 31 and the second substrate 32 (P-9), a sealing material is coated to the inside of the outer peripheral edge, both of the substrates are assembled by bonding to each other, and the liquid crystal layer 10 is sealed to the inside (P-10).

Finally, a first polarizer plate 41 and a second polarizer plate 42 are arranged to the outside of the first substrate 31 and the second substrate 32 respectively (P-11). The transmission axis of the first polarizer plate 41 and that of the second polarizer plate 42 are arranged such that they are in perpendicular and in parallel to the aligning direction of the liquid crystal layer, respectively.

The manufacturing process of the liquid crystal panel of the second embodiment is as has been described above.

As in this embodiment, when the material for forming the retardation layer with addition of the phosphine oxide photopolymerization initiator is used, increase in the pattern width of the retardation layer 38 is restricted to such an extent that it is larger by about 3 to 5 μm than the designed width of the mask opening. Accordingly, it is also possible to make the finest portion of the pattern width to 20 μm or less. Then, the reproducibility of the photomask can be improved and high refinement of the liquid crystal panel can be attained. Further, in the manufacturing step, the margin for the positioning accuracy upon pattern exposure is increased and product failure attributable to misalignment in the exposure is decreased.

The usefulness of the phosphine oxide photopolymerization initiator is to be described with reference to a comparative example. In the comparative example, as shown by the chemical formula 4, a general-purpose photopolymerization initiator, for example, IRUGACURE (R) 907, IRUGACURE 369, manufactured by Ciba Specialty Chemicals, or 2-(3,4-metehylene dioxyphenyl)-4,6-bis(trichloromethyl)-1,3,5-triazine was used.

In a case of adding one or more photopolymerization initiator selected from those described above, it is considered that the polymerization rate is high and the degree of polymerization is high, and the pattern is cured excessively to more than the width (size) of the mask opening upon pattern exposure, and the pattern width after development increases to more than the width of the mask opening by about 10 to 15 μm. On the other hand, in a case of using the opening mask of about 5 μm, the difference of the film thickness becomes remarkable between a portion just below the opening and an excessively cured portion making the in-plane thickness not uniform. Accordingly, it is difficult to form a pattern width of 20 μm or less. Further, since the photopolymerization initiator including the residues remains to the inside of the phase difference material even after the completion of the reaction, it is difficult to increase the transmittance of the retardation layer 38 to 95% or higher to a visible light (light at a wavelength within a range from 400 nm to 800 nm) and it is usually within a range of 90% or less and coloration of the layer cannot be suppressed. Further, since the phase difference material layer formed as the transparent layer 38n remains also in the transmissive display area TA, transmittance of the transmissive display area TA is lowered by coloration (transmittance, 90% or less at 400 nm).

On the other hand, it is known that the phosphine oxide photopolymerization initiator has a photobleaching function and since it does not cause coloration attributable to the photopolymerization initiator, the transmittance of the retardation layer 38 can be made within a range of 95% or higher to the visible light (light at a wavelength of 400 nm to 800 nm) and coloration of the retardation layer 38 can be suppressed.

should be deleted because of the same content as [0122])

Further, it is known that the phosphine photopolymerization initiator has a photobleaching function and since it does not cause coloration attributable to the photopolymerization initiator, the transmittance of the retardation layer 38 can be made within a range of 95% or higher to the visible light (light at a wavelength of 400 nm to 800 nm) and coloration of the layer can be suppressed.

The transflective type liquid crystal panel manufactured as described above was connected to a driving device, a backlight is disposed at the back to constitute a liquid crystal display device, and the display state was observed. When it was observed in a light place in a state of putting off the backlight, display images by reflective display could be confirmed. Then, when the display state was observed in a dark place in a state of putting on the backlight, display images by transmissive display could be confirmed. Even when the observing direction relative to the normal to the substrate was changed for a wide range, contrast reversal did not occur and the contrast ratio was less lowered.

Further, in the liquid crystal display device of this embodiment, a retardation layer material with less adhesion to the sealing material is not present between the sealing material and the first substrate 31. Accordingly, the first substrate 31 and the second substrate 32 are secured firmly, and displacement or defoliation of both of the substrates due to application of an external force can be avoided to obtain a overall environment type display device of a fast structure.

Examples of the preferred embodiments of the invention have been described above.

According to the embodiments applied with the invention, a display device of high image quality comparable with that of a large-scale monitor can be carried about and by using the same as a display device for mobile phones, image information at high quality can be reproduced and handling of image information at high level is possible. Further, when the display device is used for digital cameras, images before photographing and images after photographing can be confirmed easily. While it is expected that the receiving states in mobile type televisions can be improved remarkably along with popularization of digitalized terrestrial broad casting, when the display device of the invention is used for the mobile type televisions, image information at high quality can be reproduced irrespective of locations.

Further, according to the invention, excess curing of the material for forming the retardation layer is suppressed and the pattern reproducibility near the designed values can be attained. As a result, further refinement is possible for liquid crystal panels, the positioning margin upon pattern exposure in the manufacturing step can be improved, and product failure due to positional displacement can be decreased.

The liquid crystal display device of the invention is an overall environment type display device of a fast structure capable of display under various circumstances including from outdoor in the fine weather to dark rooms and can provide display with a wide view angle for transmissive display comparable with that of a monitor.

As has been described above, the present invention has a feature in the addition of the photopolymerization initiator having a phosphine oxide structure to the liquid crystal monomer as the phase difference material upon forming the built-in retardation layer. Such a method of forming the retardation layer is applicable to the manufacture of the liquid crystal display devices of various systems having built-in retardation layer. That is, the invention is not restricted to the IPS system but is applicable also to the manufacture of liquid crystal display devices, for example, of a TN (Twisted Nematic) system, or a VA (Vertical Alignment) system having a built-in retardation layer.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A liquid crystal display device having a reflective display area and a transmissive display area, the display device including;
a first substrate, a second substrate, and a liquid crystal layer put between the first substrate and the second substrate, and having
a built-in retardation layer between the first substrate and the second substrate, in which the retardation layer is formed by polymerizing a liquid-crystalline acrylate monomer by using a photopolymerization initiator having a phosphine oxide structure.

2. A liquid crystal display device having a reflective display area and a transmissive display area, the display device including;
a first substrate, a second substrate, a liquid crystal layer, a first alignment film, a second alignment film, a third alignment film, a pixel electrode, a common electrode, a retardation layer, a material layer for the retardation layer, a sealing material, a first polarizer plate, and a second polarizer plate, in which
the liquid crystal layer is sandwiched in an opposing space between the first substrate and the second substrate,
the first alignment film is disposed between the liquid crystal layer and the first substrate,
the second alignment film is disposed between the liquid crystal layer and the second substrate,
the pixel electrode and the common electrode are disposed on every pixel at the main surface of the second substrate,
the reflective display area and the transmissive display area are disposed on every pixel,
the retardation layer is disposed on the side of the main surface of the second substrate at a portion corresponding to the reflective display area,
the sealing material seals the liquid crystal layer surrounding a portion between the peripheral edges of the first substrate and the second substrate,
the first polarizer plate is disposed to the outer surface of the first substrate,
the second polarizer plate is disposed to the outer surface of the second substrate, and
the material for forming the retardation layer is formed by polymerizing a liquid-crystalline acrylate monomer by using a photopolymerization initiator having a phosphine oxide structure.

3. A liquid crystal display device according to claim 1, wherein the transmittance of the retardation layer is 95% or higher to a visible light (light at a wavelength within a range of 400 nm to 800 nm).

4. A liquid crystal display device according to claim 1, wherein the retardation layer is formed in a pattern with a width of 20 μm or less for the finest portion.

5. A liquid crystal display device according to claim 1, wherein the retardation layer is disposed between the first substrate and the liquid crystal layer.

6. A liquid crystal display device according to claim 2, wherein the transmission axis of the first polarizer plate and that of the second polarizer plate are disposed in perpendicular to each other.

7. A liquid crystal display device according to claim 6, wherein one of the transmission axis of the first polarizer plate and the transmission axis of the second polarizer plate is disposed in parallel with the aligning direction of the liquid crystal layer.

8. A liquid crystal display device according to claim 1, wherein the retardation of the liquid crystal layer in the reflective display area is ¼ wavelength and
the retardation of the retardation layer is ½ wavelength.

9. A liquid crystal display device according to claim 2, wherein the liquid crystal layer is aligned homogeneously,
the transmission axis of the first polarizer plate is in parallel with the aligning direction of the liquid crystal layer,
the azimuth of the retardation axis of the retardation layer is such that the angle formed relative to the transmission axis of the first polarizer plate is 20° or more and 25° or less, or 60° or more and 75° or less.

10. A liquid crystal display device according to claim 1, wherein a thickness adjusting layer is provided to a layer above the retardation layer.

11. A liquid crystal display device according to claim 10, wherein
a protective film comprising a transparent resin is provided covering the retardation layer and disposed to a layer below the thickness adjusting layer.

12. A method of manufacturing a liquid crystal display device having a reflective display area and a transmissive display area, the liquid crystal display device including;
a first substrate, a second substrate, and a liquid crystal layer put between the first substrate and the second substrate,
having a built-in retardation layer between the first substrate and the second substrate,
the manufacturing method including a step of forming the retardation layer by using a liquid-crystalline acrylate monomer and a photopolymerization initiator having a phosphine oxide structure.

13. A method of manufacturing a liquid crystal display device in which a liquid crystal layer is sandwiched in an opposing gap between a first substrate and a second substrate, the first substrate and the second substrate are sealed at the outer peripheral edge of the display region thereof by a sealing material, the display region is constituted with a matrix arrangement of a plurality of pixels and a reflective display area and a transmissive display area are disposed on every pixel, the method including;
a step of forming an alignment film for retardation layer to the main surface of the first substrate and providing the alignment film for the retardation layer with an alignment control function,
a coating step for the retardation layer material of coating a photocurable acrylated nematic liquid crystal monomer with addition of a photopolymerization initiator having a phosphine oxide structure as a retardation layer material while covering the alignment film for the retardation layer,
an exposure step of selectively exposing to cure a portion of the retardation layer material corresponding to the reflective display area, and
an unexposed portion removing step of removing the retardation layer material at a portion corresponding to the transmissive display area.

14. A method of manufacturing a liquid crystal display device in which a liquid crystal layer is sandwiched in an opposing gap between a first substrate and a second substrate, the first substrate and the second substrate are sealed at the outer peripheral edge of the display region thereof by a sealing material, the display region is constituted with a matrix arrangement of a plurality of pixels and a reflective display area and a transmissive display area are disposed on every pixel, the method including;
a step of forming an alignment film for retardation layer to the main surface of the first substrate and providing the alignment film for the retardation layer with an alignment control function,
a coating step for the retardation layer material of coating a photocurable acrylated nematic liquid crystal monomer with addition of a photopolymerization initiator having a phosphine oxide structure as a retardation layer material while covering the alignment film for the retardation layer,
an exposure step of selectively exposing to cure a portion of the retardation layer material corresponding to the reflective display area, and
a step of transparentizing an unexposed portion which is a portion corresponding to the transmissive display area of the retardation layer material to or higher than the nematic-isotropic transition temperature, and curing the portion by photo-irradiation in the heated state as it is.

15. A manufacturing method of a liquid crystal display device according to claim 13, including a step of forming a thickness adjusting layer to a layer above the retardation layer.

16. A manufacturing method of a liquid crystal display device according to claim 14, including a step of forming a thickness adjusting layer to a layer above the retardation layer.

17. A manufacturing method of a liquid crystal display device according to claim 15, including a step of forming a protective layer comprising a transparent resin while covering the retardation layer and a residual layer of the forming material for forming the retardation layer to a layer below the thickness adjusting layer.

18. A manufacturing method of a liquid crystal display device according to claim 16, including a step of forming a protective layer comprising a transparent resin while covering the retardation layer and a residual layer of the forming material for forming the retardation layer to a layer below the thickness adjusting layer.
